(19) United States
(12) Patent Application Publication
(10) Pub. No.: US 2011/0285975 A1
(43) Pub. Date: Nov. 24, 2011

(54) METHOD OF MANAGING EUV EXPOSURE MASK AND EXPOSURE METHOD

(76) Inventor: Kazuo TAWARAYAMA, Tsukuba-shi (JP)

(21) Appl. No.: 13/051,864

(22) Filed: Mar. 18, 2011

(30) Foreign Application Priority Data
May 20, 2010 (JP) 2010-116598

(51) Int. Cl. G03B 27/52

(52) U.S. Cl. 355/30

(57) ABSTRACT

According to one embodiment, there is provided a method of managing an EUV exposure mask to manage a cleaning period of the EUV exposure mask set in an exposure apparatus, including obtaining mark profile signals corresponding to two different directions of an alignment mark provided on the mask by irradiating the mark with EUV light and detecting light reflected by the mask, measuring dimensions of the mark in the two different directions from the obtained mark profile signals, calculating a difference between the measured dimensions in the two different directions, and determining the cleaning period of the mask based on the calculated difference.

### CROSS-REFERENCE TO RELATED APPLICATIONS

This application is based upon and claims the benefit of priority from Japanese Patent Application No. 2010-116598, filed May 20, 2010; the entire contents of which are incorporated herein by reference.

### FIELD

Embodiments described herein relate generally to a method of managing an EUV exposure mask for use in a lithography process which uses EUV (extreme ultraviolet radiation) light for an exposure light source, and an exposure method using the EUV exposure mask.

### BACKGROUND

In recent years, an EUV exposure apparatus is attracting a great deal of attention as a lithography technique which resolves an ultrafine pattern as small as 50 nm or less. The EUV exposure wavelength is as very short as about 13.5 nm, so neither a transparent material nor a material capable of transmitting EUV light exists in a wavelength range including this wavelength. Hence, a reflective optical system is adopted as an optical system for an EUV exposure apparatus, in place of a transmissive optical system. Similarly, a reflective mask formed from a multilayer film is under development as an EUV exposure mask, in place of a transmissive mask.

An EUV exposure apparatus inevitably has a problem that the surface of a multilayer reflecting layer is contaminated by contamination such as a hydrocarbon layer. This is because the interior of the exposure apparatus is not in a perfect vacuum, and is therefore under an environment in which organic gases such as hydrocarbons are present upon charging components to be used in the apparatus and a wafer coated with a photoresist into the vacuum inside the apparatus.

On the surface of a reflective mask for EUV exposure, EUV light also impinges on a light-shielding pattern formed on a reflecting layer, so a hydrocarbon layer is also formed on the surface of the light-shielding pattern. The hydrocarbon layer which adheres onto the light-shielding pattern adheres not only onto its upper portion but also onto its side wall portion. Therefore, the dimensions of the light-shielding pattern transferred onto the wafer get larger in appearance, and this deteriorates the dimensional accuracy of the pattern formed on the wafer by exposure using the mask.

To avoid the above-mentioned problem, the contamination adhering on the mask surface need only be removed by cleaning. However, frequent cleaning of the mask surface not only degrades the mask quality but also lowers the exposure throughput.

### BRIEF DESCRIPTION OF THE DRAWINGS

FIG. 1 is a view showing the entire arrangement of an EUV exposure mask used in the first embodiment;

FIG. 2 is a view illustrating an example of an alignment mark provided on the mask shown in FIG. 1;

FIGS. 3A and 3B are graphs showing a mark profile signal when no contamination is present and that when contamination is deposited, respectively;

FIGS. 4A and 4B are graphs showing mark profile signals in the X and Y directions, respectively;

FIGS. 5A, 5B, 5C, and 5D are views for explaining the detection principle of a mark profile signal;

FIG. 6 is a view showing the arrangement of an EUV exposure apparatus used in the first embodiment;

FIG. 7 is a flowchart showing the sequence of a mask management method according to the first embodiment;

FIG. 8 is a block diagram showing the configuration of an EUV exposure system used in the second embodiment;

FIG. 9 is a flowchart showing the sequence of a mask management method according to the second embodiment; and

FIG. 10 is a graph showing the relationship between the irradiation energy applied to a mask, and the amount of deposition of contamination.

### DETAILED DESCRIPTION

In general, according to one embodiment, there is provided a method of managing an EUV exposure mask to manage a cleaning period of the EUV exposure mask set in an exposure apparatus, comprising:

obtaining mark profile signals corresponding to two different directions of an alignment mark provided on the mask by irradiating the mark with EUV light and detecting light reflected by the mask;

measuring dimensions of the mark in the two different directions from the obtained mark profile signals;

calculating a difference between the measured dimensions in the two different directions; and

determining the cleaning period of the mask based on the calculated difference.

Various embodiments will be hereinafter described with reference to the accompanying drawings.

### First Embodiment

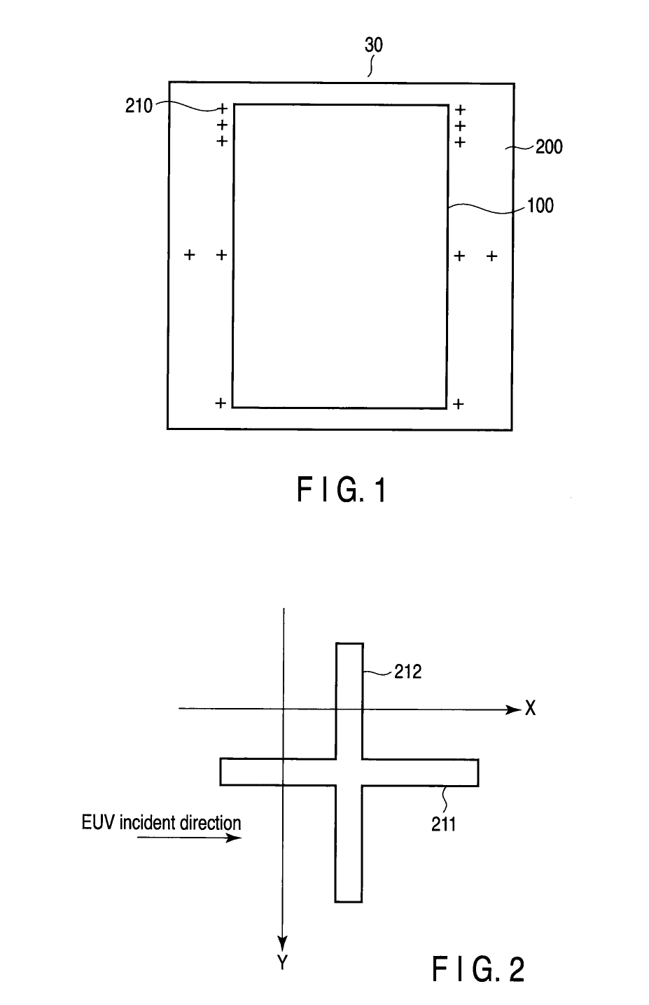

FIG. 1 is a view showing an example of the entire layout of a reflective mask for EUV exposure used in this embodiment.

A mask 30 used in this embodiment includes a pattern region 100 in which a device pattern etc. are located, and a peripheral region 200 which surrounds the pattern region 100. In each of the pattern region 100 and peripheral region 200, a reflecting surface is formed by alternately stacking a molybdenum (Mo) thin film and a silicon (Si) thin film more than once. Various types of patterns are formed by providing light-shielding patterns on the reflecting surface.

Various types of marks such as reticle alignment marks 210 used to position the mask 30 within the exposure apparatus, and accuracy assurance marks used to check the quality of the mask 30, are located in the peripheral region 200. These marks are also light-shielding patterns, and the alignment marks 210 are aligned in the direction in which the mask 30 is scanned.

The irradiation region of EUV light is wider than the pattern region 100 in the horizontal direction on the paper surface in FIG. 1, but is narrower than the pattern region 100 in the vertical direction on the paper surface in FIG. 1. Therefore, the entire surface of the mask 30 cannot be irradiated with EUV light by full-field exposure. To combat this situation, the mask 30 is scanned (the wafer is simultaneously scanned) in the vertical direction on the paper surface, thereby making it possible to irradiate the entire surface of the mask 30 with EUV light.

As shown in FIG. 2, the alignment mark 210 includes a linear portion 211 elongated in the X direction parallel to the EUV light incident direction, and a linear portion 212 elongated in the Y direction perpendicular to the EUV light incident direction, and is formed in, e.g., a cross shape.

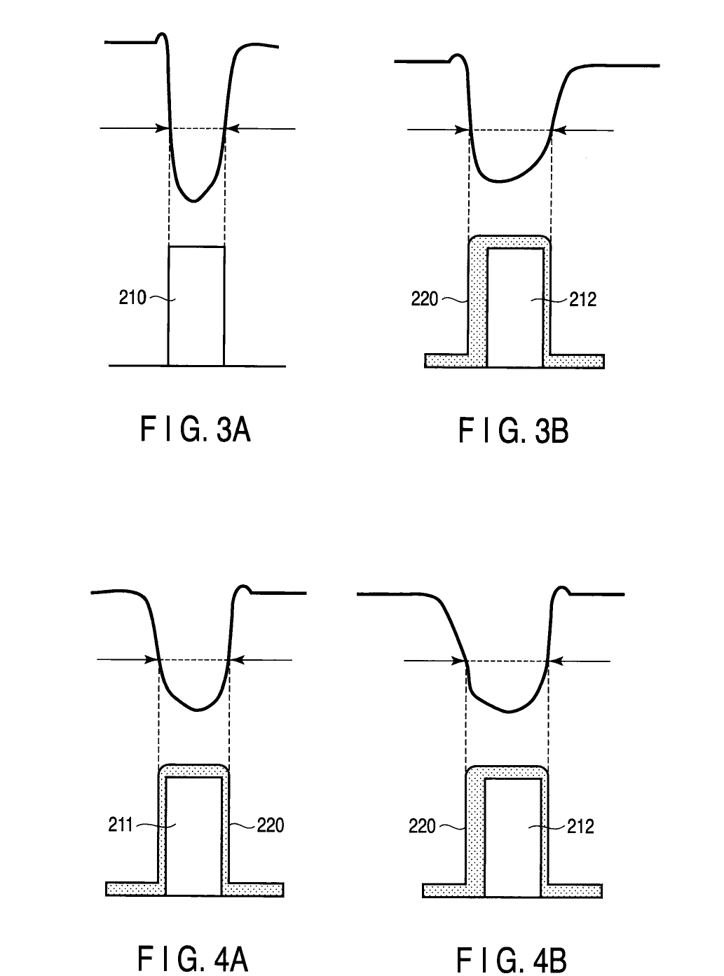

By applying EUV light onto the alignment mark 210, and detecting light reflected by it using, e.g., a CCD sensor, a reflection signal can be obtained. As shown in FIG. 3A, by extracting a mark signal profile in the X direction parallel to the EUV incident direction, the line width (dimension) of the mark 210 in the X direction can be measured. If no contamination is deposited on the mark 210, the dimension of the mark 210 can be precisely measured. However, as shown in FIG. 3B, if contamination 220 is deposited on the mark 210, the dimension of the mark 210 is measured as a dimension larger than the actual dimension. This means that the width of the device pattern in the pattern region 100 increases upon irradiating the pattern region 100 with EUV light.

When the device pattern, the marks 210, etc. which are located on the mask 30 are repeatedly irradiated with EUV light serving as exposure light in a certain atmosphere, the contamination 220 covers these patterns upon adhesion/deposition, as shown in FIG. 3B. The deposition rate of contamination 220 which deposits on the mask 30 is higher in a direction perpendicular to the EUV light incident direction, but is lower in a direction parallel to this incident direction. Therefore, the alignment mark 210 including the linear portions 211 and 212 in which EUV light is incident on the mask pattern in different directions has a dimension change rate which differs depending on the direction in which the linear portions 211 and 212 extend. The difference between the line width in a direction perpendicular to the EUV light incident direction and that in a direction parallel to this incident direction increases in proportion to the number of times of EUV irradiation, i.e., the frequency of use of the mask 30.

Hence, by obtaining the difference between the line width in a direction perpendicular to the EUV light incident direction and that in a direction parallel to this incident direction, the amount of deposition of contamination 220 on the EUV exposure mask 30 can be estimated. This makes it possible to determine the cleaning period of the mask 30.

FIGS. 4A and 4B are graphs showing contamination formed on the mark 210, and mark profile signal waveforms. FIG. 4A shows a case in which the line width of the linear portion 211 in the X direction parallel to the EUV light incident direction is measured, and FIG. 4B shows a case in which the line width of the linear portion 212 in the Y direction perpendicular to the EUV light incident direction is measured.

As shown in FIG. 4A, the EUV light does not directly strike the side wall surfaces parallel to the

EUV light incident direction, so the amount of deposition of contamination is small on both of these side wall surfaces. On the other hand, as shown in FIG. 4B, the amount of deposition of contamination is large on the left side wall surface (in the light) which is directly irradiated with the EUV light and is small on the right side wall surface (in the shade) which is not directly irradiated with the EUV light.

In other words, the dimension of the linear portion 212 in the mark 210 is larger than that of the linear portion 211 in the mark 210. This difference increases as the amount of deposition of contamination 220, which is proportional to the frequency of use of the mask 30, increases. Hence, as described earlier, when the line widths of the mark 210 in different directions with respect to the exposure light are obtained from the profiles of mark detection signals, the amount of deposited contamination 220 can be estimated from these line widths.

Note that to detect the alignment mark 210 on the mask 30, a CCD sensor which detects light reflected by the mask 30 can be provided in an EUV exposure apparatus. As another method, a sensor which detects a mark on the wafer and is provided in an EUV exposure apparatus can also be used (see, e.g., Jpn. Pat. Appln. KOKAI Publication No. 2006-30021).

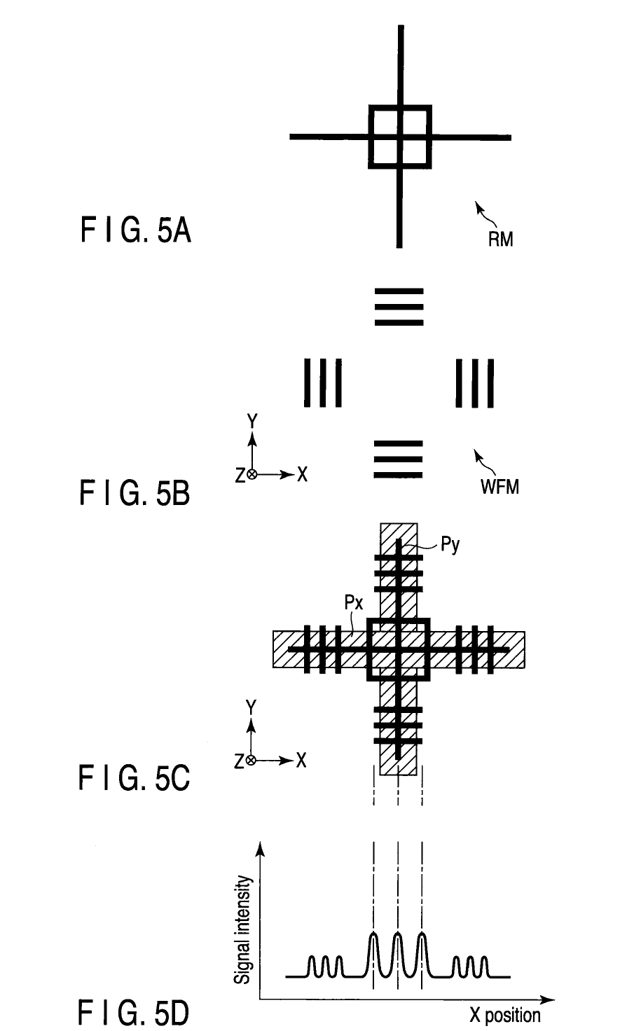

More specifically, an alignment mark RM, as shown in FIG. 5A, is provided on the mask, and a reference mark WFM, as shown in FIG. 5B, is provided on the wafer. When light reflected by the mask strikes the surface of the wafer upon irradiation with EUV light, the alignment mark RM on the mask is projected onto the reference mark WFM on the wafer, as shown in FIG. 5C. By receiving light that bears information of these marks using, e.g., a photosensor which detects a mark on the wafer, an alignment signal, as shown in FIG. 5D, can be obtained. From the alignment signal, the dimensions of the alignment mark 210 on the mask 30 can be measured.

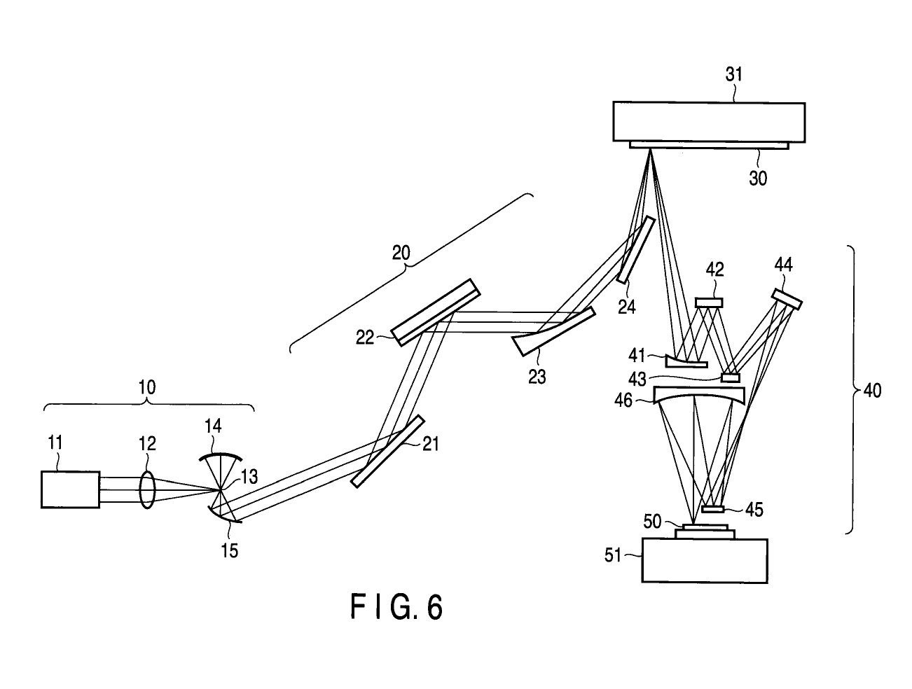

FIG. 6 is a view showing the schematic arrangement of an EUV exposure apparatus used in this embodiment, and illustrates a step-and-scan reduction projection exposure apparatus as an example.

The exposure apparatus includes a light source unit 10 which emits EUV light, an illumination optical system 20 which guides the EUV light emitted by the light source unit 10, a mask (reflective reticle) 30 irradiated with the light propagated through the illumination optical system 20, and a mask stage 31 which holds the mask 30. The exposure apparatus also includes a projection optical system 40 which guides light reflected by the mask 30, a wafer 50 coated with a resist film to be exposed to the light propagated through the projection optical system 40, and a wafer stage 51 which holds the wafer 50.

The light source unit 10 includes a light source 11, condenser lens 12, elliptical mirror 14, and parabolic mirror 15. The light source 11 emits laser light with wavelengths in the infrared to visible range. Examples of the light source 11 are an yttrium-aluminum-garnet (YAG) laser which uses semiconductor laser excitation, a CO₂ laser, and an excimer laser. The condenser lens 12 is placed to be adjacent to the light source 11. The condenser lens 12 converges the laser light emitted by the light source 11 on a focal point 13. The focal point 13 is supplied with xenon (Xe) gas. The Xe gas heats up upon irradiation with laser light. Xe is excited to a plasma state, and emits EUV light with soft X-ray wavelengths of 12 nm to 14 nm in the process of transition to a low-potential state. The emitted EUV light is focused by the elliptical mirror 14 and reflected by the parabolic mirror 15.

The illumination optical system 20 which guides the EUV light reflected by the parabolic mirror 15 includes reflecting mirrors 21 and 22, a condenser mirror 23, and an optical path bending mirror 24. The EUV light is reflected by the reflecting mirrors 21 and 22 and further reflected and focused by the condenser mirror 23. The EUV light reflected and focused by the condenser mirror 23 is reflected by the optical path bending mirror 24, thereby reaching the mask 30 fixed on the mask stage 31 by an electrostatic attractive force.

The projection optical system 40 is placed below the mask 30. The wafer stage 51 which holds the wafer 50 is placed below the projection optical system 40. The projection optical system 40 includes a condenser mirror 41, optical path bending mirrors 42 and 43, a condenser mirror 44, an optical path bending mirror 45, and a condenser mirror 46. The EUV light reflected by the mask 30 is reflected and focused by the condenser mirror 41 and reflected by the optical path bending mirrors 42 and 43. The EUV light is further reflected and focused by the condenser mirror 44 and reflected by the optical path bending mirror 45. The EUV light reflected by the optical path bending mirror 45 is focused and reflected by the condenser mirror 46, thereby making a focal point on the resist film coated on the surface of the wafer 50. The projection optical system 40 has a magnification of, e.g., ¼. Because EUV light is absorbed by the air, the illumination optical system 20 and projection optical system 40, for example, are preferably maintained under a vacuum environment.

In such an arrangement, the illumination optical system 20 obliquely irradiates the mask 30 with the EUV light, and the projection optical system 40 irradiates the surface of the wafer 50 with light reflected by the mask 30. Therefore, the pattern of the mask 30 is reduced and transferred onto the wafer 50 by the projection optical system 40. At this time, the mask stage 31 and wafer stage 51 are synchronously scanned in accordance with the reduction ratio of the projection optical system 40.

The exposure apparatus performs exposure by repeating a step-and-scan operation. After exposure on the entire surface of the wafer 50 is completed, the wafer 50 is replaced with the next wafer. Further, after exposure on all wafers is completed, the mask 30 is replaced and exposure is repeated again in accordance the same procedure. To align the position of the wafer 50 in the Z direction (the optical axis direction of the projection optical system), the surface position of the wafer 50 is measured by a level position detection sensor (Z sensor), and its level position is controlled in accordance with the measured information.

In an EUV exposure apparatus of this type, the interior of the apparatus is not in a perfect vacuum, and is therefore under an environment in which organic gases such as hydrocarbons are always present. The residual gas containing hydrocarbons results from, e.g., an oil used for a vacuum exhaust system (vacuum pump), a lubricant which forms the movable portion inside the apparatus, and components (e.g., coating materials of electrical cables) used for the interior of the apparatus.

In an EUV exposure apparatus, a wafer coated with a photoresist is charged into a vacuum inside the apparatus. When the wafer is irradiated with EUV light, a gas containing hydrocarbons is released by, e.g., evaporation of the residual solvent and decomposition/desorption of a resin which forms the resist. Gas molecules containing hydrocarbons are physically adsorbed into the surface of a multilayer reflecting layer. The physically adsorbed gas molecules repeat desorption and adsorption, and therefore do not grow thicker as long as they are kept intact.

However, when the substrate is irradiated with EUV light, secondary electrons are generated inside the substrate in the reflecting layer and decompose the gas molecules which contain hydrocarbons and are adsorbed into the surface, thereby precipitating carbon. As the adsorbed gas molecules are sequentially decomposed to precipitate carbon, a carbon layer is formed on the surface of the multilayer reflecting layer, and the thickness of the carbon layer increases in proportion to the amount of irradiation with the EUV light.

On the surface of a reflective mask for EUV exposure, EUV light also impinges on a light-shielding pattern formed on a reflecting layer, so a hydrocarbon layer is also formed on the surface of the light-shielding pattern. The hydrocarbon layer which adheres onto the light-shielding pattern adheres not only onto its upper portion but also onto its side wall portion. Therefore, the dimensions of the light-shielding pattern get larger in appearance, and this deteriorates its dimensional accuracy.

This embodiment provides a method of precisely predicting the amount of deposition of contamination such as hydrocarbons as mentioned above, thereby appropriately determining the mask cleaning period.

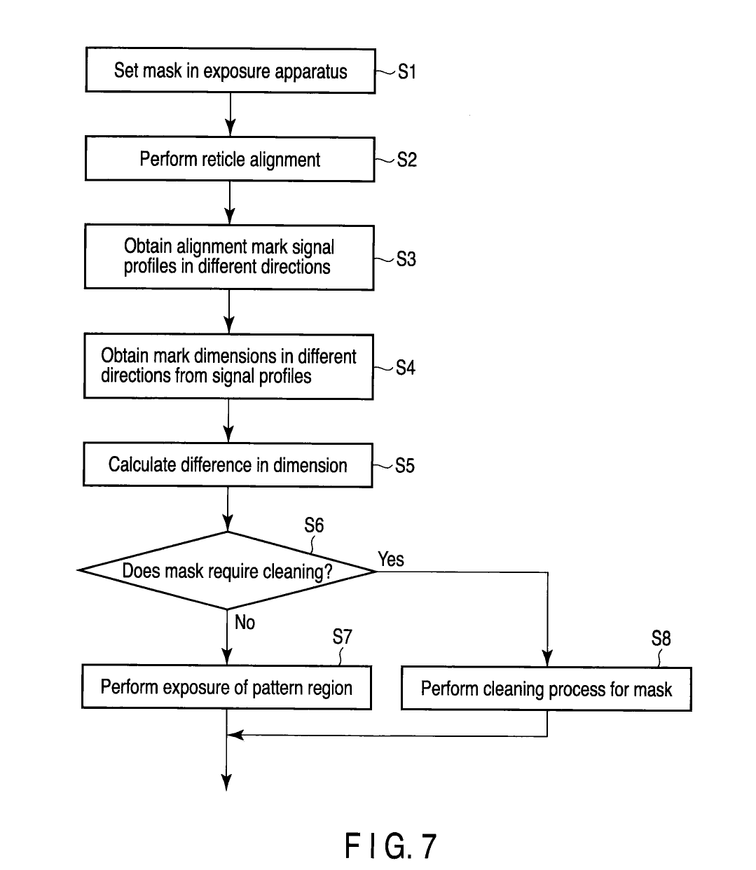

FIG. 7 is a flowchart for explaining the sequence of a mask management method according to this embodiment.

First, an EUV exposure mask 30 is transported into the exposure apparatus by a transport mechanism (step S1). The mask 30 is used for exposure by irradiation with EUV light as the need arises, and mask alignment is performed in every exposure operation. That is, the position of the mask 30 is aligned using an alignment mark 210 located on the mask 30 (step S2).

More specifically, EUV light for use in actual exposure is applied to the alignment mark 210, a reference mark provided on the wafer stage is observed across the alignment mark, and the signal profiles of the mark position are obtained in order to align the positions of these two marks (step S3). An operation of detecting the positions of the alignment mark and reference mark from the signal profiles, and aligning their positions without a shift is performed.

From the signal profiles obtained at this time, an appropriate slice level is set, thereby making it possible to obtain the line widths of the alignment mark 210, as shown in FIGS. 4A and 4B. As described earlier, the alignment mark 210 includes linear portions 211 and 212 in the X and Y directions, respectively, so the line widths of the alignment mark 210 in different directions with respect to the exposure light can be obtained (step S4).

The difference between the dimensions in the X and Y directions is calculated (step S5). This difference in dimension is proportional not only to the amount of deposition of contamination 220 deposited in a peripheral region 200 but also to that of contamination 220 deposited in a pattern region 100.

The amount of deposition of contamination 220 is estimated from the calculated difference in dimension to determine whether the mask 30 requires cleaning (step S6).

If it is determined that the mask 30 does not require cleaning, the pattern region 100 is exposed as usual (step S7). On the other hand, if it is determined that the mask 30 requires cleaning, a cleaning process for the mask 30 is performed (step S8). These types of contamination 220 can be removed by acid cleaning used in the normal process of cleaning a photomask for light exposure (e.g., Jpn. Pat. Appln. KOKAI Publication No. 2004-53817).

In this manner, according to this embodiment, by measuring the line widths, in the X and Y directions, of the alignment marks 210 on the EUV exposure mask 30, and determining whether the difference between these line widths falls outside a tolerance, the cleaning period of the mask 30 can be appropriately determined. Hence, a cleaning process for the mask 30 can be performed at an optimum timing without deteriorating the dimensional accuracy of the exposure pattern, thus improving the throughput of the exposure apparatus. Moreover, the mask 30 can be prevented from being cleaned more than necessary, thus suppressing degradation in quality of the mask 30 upon cleaning.

### Second Embodiment

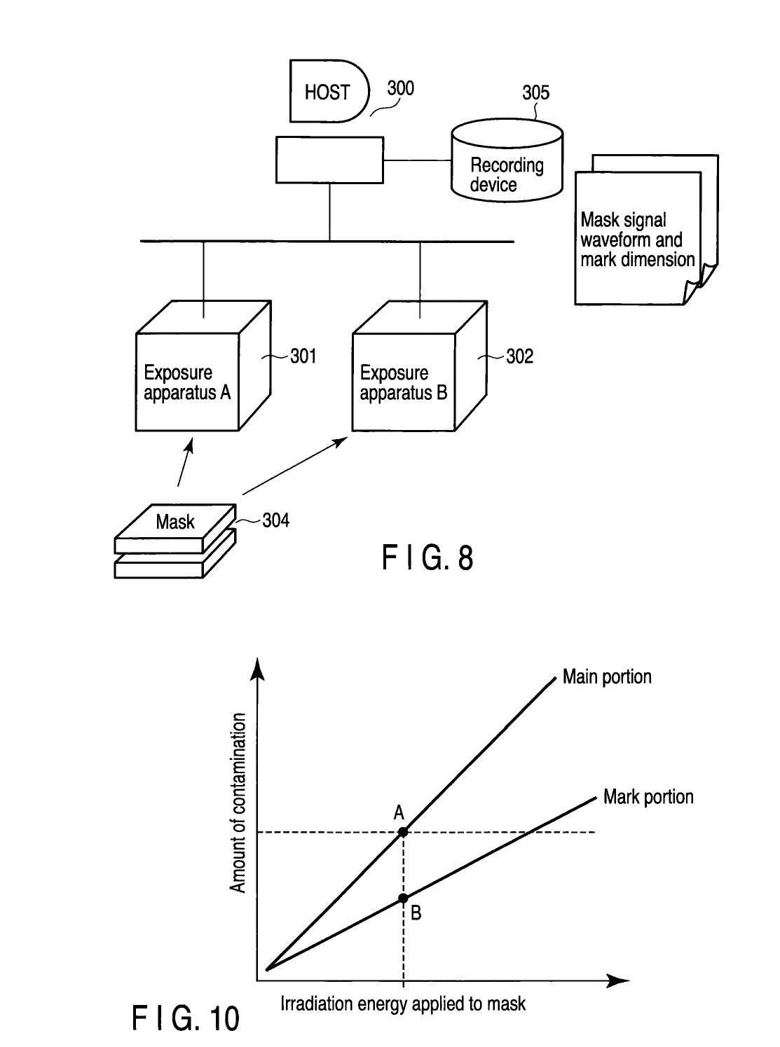

FIG. 8 is a block diagram showing the basic configuration of an EUV exposure system used in the second embodiment.

A plurality of EUV exposure apparatuses 301 and 302 are under the control of a host computer 300. In each of the exposure apparatuses 301 and 302, a mask dimension based on an alignment signal profile obtained by exposure using an EUV mask 30 is recorded on a recording device 305.

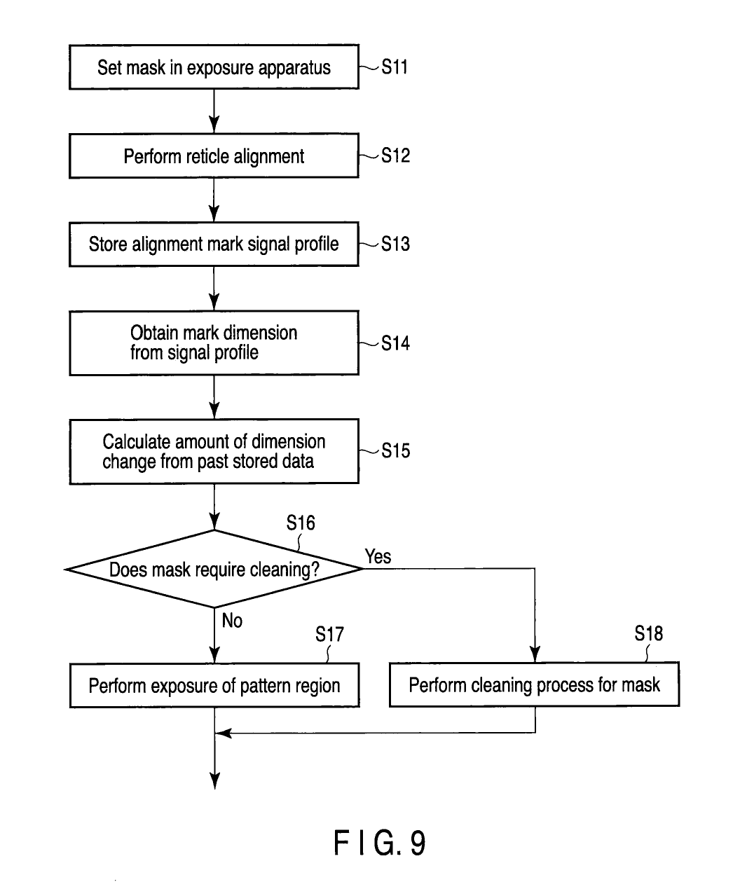

FIG. 9 is a flowchart showing the sequence of a mask management method according to this embodiment.

The mask 30 is used for exposure by irradiation with EUV light as the need arises, and mask alignment is performed in every exposure operation. An alignment signal profile obtained upon this exposure operation is recorded on the recording device 305 and stored as a history of the mask 30. Since the accumulated irradiation energy applied to the mask 30 can be determined from the history, the accumulated irradiation energy and the amount of deposition of contamination 220 deposited on the mask 30 can be obtained.

First, an EUV exposure mask 30 is transported into the exposure apparatus by a transport mechanism (step S11), as in the first embodiment. Next, the position of the mask 30 is aligned using an alignment mark 210 located on the mask 30 (step S12). A signal profile obtained at this time is stored in the recording device 305 (step S13). The mark dimension is obtained from the signal profile (step S14).

The amount of dimension change is calculated from the past stored data (step S15). This amount of dimension change is proportional not only to the amount of deposition of contamination 220 deposited in a peripheral region 200 but also to that of contamination 220 deposited in a pattern region 100.

The amount of deposition of contamination 220 is estimated from the calculated amount of dimension change to determine whether the mask 30 requires cleaning (step S16).

If it is determined that the mask 30 does not require cleaning, the pattern region 100 is exposed as usual (step S17). On the other hand, if it is determined that the mask 30 requires cleaning, a cleaning process for the mask 30 is performed (step S18). The mask 30 can be cleaned by acid cleaning, as in the first embodiment.

In this manner, according to this embodiment, by storing an alignment signal profile obtained upon mask alignment and a mark dimension based on it, and estimating the amount of deposition of contamination 220 from the amount of dimension change stored upon every exposure, the cleaning period of the EUV exposure mask 30 can be appropriately determined. Hence, the same effect as in the first embodiment described earlier can be obtained.

Note that in mask alignment, the mask 30 is irradiated with EUV light only during alignment before exposure. However, the frequency of use or the required irradiation energy is higher for the main portion (pattern region 100) than for the mark portion (peripheral region 200). Thus, the amount of deposition of contamination 220 often differs between the mark portion and the main portion.

The amount of deposition of contamination 220 in the main portion of the mask 30 is of prime importance in practice, so a fluctuation in dimension of the main portion due to factors associated with the contamination 220 adversely affects the manufacturing yield.

To prevent this, as shown in FIG. 10, the change of contamination in the peripheral region 200 and that of contamination in the pattern region 100 are tabulated, and the amount of contamination in the main portion is predicted from that of contamination in the mark portion. That is, the time at which an amount of contamination B in the mark portion corresponding to an amount of contamination A that falls within a tolerance for the pattern region 100 is detected is determined as a cleaning period. This makes it possible to more precisely determine the cleaning period in the main portion.

### Modification

Note that the present invention is not limited to the above-mentioned embodiments. The arrangement of an EUV exposure apparatus is not particularly limited to that shown in FIG. 6, and can be changed as needed in accordance with the specification. Any EUV exposure apparatus can be adopted as long as it obliquely irradiates an exposure mask with EUV light, and guides light reflected by the mask onto a wafer, thereby projecting the pattern on the mask onto the wafer. Also, the shape of an alignment mark provided on the mask is not particularly limited to a cross shape, and any shape can be adopted as long as this mark includes a linear portion parallel to the EUV incident direction and that perpendicular to the EUV incident direction.

In the second embodiment, it is also possible to store a signal profile obtained from an alignment signal in place of the mark dimension, and determine the mask cleaning period based on the history of the signal profile. Also, the signal contrast may be stored as one of signal profiles.

Although the cleaning period of an EUV exposure mask is determined in the embodiments, the present invention is also applicable to determination of the cleaning period of a reflective optical system in an exposure apparatus as long as a reflection signal proportional to the amount of deposition of contamination on the reflective optical system in the exposure apparatus can be detected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of managing an EUV exposure mask to manage a cleaning period of the EUV exposure mask set in an exposure apparatus, comprising:
obtaining mark profile signals corresponding to two different directions of an alignment mark provided on the mask by irradiating the mark with EUV light and detecting light reflected by the mask;
measuring dimensions of the mark in the two different directions from the obtained mark profile signals;
calculating a difference between the measured dimensions in the two different directions; and
determining the cleaning period of the mask based on the calculated difference.

2. The method according to claim 1, wherein the mark includes a linear portion elongated in an X direction parallel to an incident direction of the EUV light, and a linear portion elongated in a Y direction perpendicular to the incident direction of the EUV light.

3. The method according to claim 2, wherein the mark is formed in a cross shape which includes a linear portion elongated in the X direction parallel to the incident direction of the EUV light, and a linear portion elongated in the Y direction perpendicular to the incident direction of the EUV light.

4. The method according to claim 2, wherein a dimension of the mark in the Y direction is measured using the linear portion of the mark, which is elongated in the X direction, a dimension of the mark in the X direction is measured using the linear portion of the mark, which is elongated in the Y direction, and it is determined that the mask requires cleaning if a difference between the dimension in the X direction and the dimension in the Y direction falls outside a tolerance.

5. The method according to claim 1, wherein determining the cleaning period includes calculating an amount of deposition of contamination from the calculated difference in dimension, and determining the cleaning period based on the amount of deposition.

6. A method of managing an EUV exposure mask to manage a cleaning period of the EUV exposure mask set in an exposure apparatus, comprising:
irradiating an alignment mark provided on the mask with EUV light and detecting light reflected by the mask;
calculating one of a dimension and signal profile of the mark from a reflection signal obtained by detecting the reflected light;
storing one of the calculated dimension and signal profile every time the mark is irradiated with EUV light; and
determining the cleaning period of the mask by calculating an amount of change in one of the dimension and signal profile based on a history of one of the stored dimension and signal profile.

7. The method according to claim 6, wherein the mark includes a linear portion elongated in an X direction parallel to an incident direction of the EUV light, and a linear portion elongated in a Y direction perpendicular to the incident direction of the EUV light.

8. The method according to claim 6, wherein the mark is formed in a cross shape which includes a linear portion elongated in the X direction parallel to the incident direction of the EUV light, and a linear portion elongated in the Y direction perpendicular to the incident direction of the EUV light.

9. The method according to claim 8, wherein in calculating one of a dimension and signal profile of the mark, one of a dimension of the mark in the X direction and a signal profile in the X direction obtained using the linear portion of the mark, which is elongated in the Y direction, is calculated.

10. The method according to claim 6, wherein determining the cleaning period includes estimating an amount of deposition of contamination on the mark from an amount of change in one of the dimension and signal profile, and determining the cleaning period based on the amount of deposition.

11. The method according to claim 6, wherein determining the cleaning period includes tabulating a relationship between contamination in a pattern region in which a device pattern is located and contamination in a peripheral region in which a mark is located, estimating an amount of deposition of contamination on the mark from an amount of change in one of the calculated dimension and signal profile, predicting an amount of contamination on the device pattern from the estimated amount of contamination on the mark, and determining the cleaning period based on the predicted amount of deposition.

12. An EUV exposure method comprising:
setting an EUV exposure mask in an exposure apparatus;
obtaining mark profile signals corresponding to two different directions of an alignment mark provided on the mask by irradiating the mark with EUV light and detecting light reflected by the mask;
measuring dimensions of the mark in the two different directions from the obtained mark profile signals;
calculating a difference between the measured dimensions in the two different directions;
determining the cleaning period of the mask based on the calculated difference; and
performing EUV exposure using the mask if it is determined that the mask does not require cleaning, and cleaning the mask if it is determined that the mask requires cleaning.

13. The method according to claim 12, wherein the mark includes a linear portion elongated in an X direction parallel to an incident direction of the EUV light, and a linear portion elongated in a Y direction perpendicular to the incident direction of the EUV light.

14. The method according to claim 12, wherein the mark is formed in a cross shape which includes a linear portion elongated in the X direction parallel to the incident direction of the EUV light, and a linear portion elongated in the Y direction perpendicular to the incident direction of the EUV light.

15. The method according to claim 14, wherein determining the cleaning period includes determining that the mask requires cleaning if the difference in dimension falls outside a tolerance.

16. The method according to claim 12, wherein determining the cleaning period includes calculating an amount of deposition of contamination from the calculated difference in dimension, and determining the cleaning period based on the amount of deposition.
